(19) United States
(12) Patent Application Publication
(10) Pub. No.: US 2019/0023545 A1
(43) Pub. Date: Jan. 24, 2019

(54) DEVICE FOR MOUNTING A FORK ON A BUCKET, AND A METHOD FOR MOUNTING A FORK ON A BUCKET

(71) Applicant: MARKPLANERARNA I NORDEN AB, Kumla (SE)

(72) Inventors: Eric SVENSSON, Kumla (SE); Harry Filip KARLSSON, Örebro (SE)

(21) Appl. No.: 16/068,253

(22) PCT Filed: Jan. 25, 2016
(86) PCT No.: PCT/SE2015/000079

§ 371 Date: Jul. 5, 2018

(51) Int. Cl. B66F 9/12; E02F 3/96

(52) U.S. Cl. CPC B66F 9/12; E02F 3/962

(57) ABSTRACT

The invention relates to a mounting device (1, 1′) for mounting a fork, comprising at least one fork blade (2), on a machine bucket (3), wherein the mounting device (1, 1′) comprises at least one pre-tensioned plate (4) arranged on said at least one fork blade (2), and at least one upper tension stop (6) against which said at least one pre-tensioned pressure plate (4) is pre-tensioned for mounting the machine bucket (3) by clamping the bucket (3) between said at least one pre-tensioned plate (4) and said at least one upper tension stop (6). The invention also relates to a mounting method for mounting a fork (2) on a bucket (3).

The present invention relates to mounting device for mounting a fork on a bucket.

### BACKGROUND

A wheel loader or an excavator, also known as a machine, is normally provided with one or more equipment mounts for mounting a piece of work equipment, such as a bucket, plow blade, snow blade, stone gripper or pallet fork intended for various tasks, preferably material handling. Various types of buckets exist, e.g. with teeth or without teeth, or buckets with a large or small bucket capacity.

Machines of said type are also equipped with a lifting set which is formed with a drive unit and two lifting arms on which two equipment mounts are arranged, one on each lifting arm. The lifting set features two hydraulic functions, one for lifting and lowering the lifting arms and one for angling the equipment mounts upward or downward. The piece of work equipment is normally mounted on the equipment mounts in a detachable manner, for example by using bolts or pins. Replacement of a piece of work equipment, such as a pallet fork for a bucket, involves carrying out several steps, i.e. removing the bolts or pins, shifting the pallet fork and bucket on the equipment mounts and refitting the bolts or pins. The steps are time-consuming and labour-intensive and also pose a working environment hazard for the machine operator or other personnel carrying out the replacement.

It is known in the literature that replacement of a piece of work equipment on a machine of said type can be simplified by mounting the piece of work equipment on a different piece of work equipment instead of shifting the pieces of work equipment on the machine equipment mounts.

A mounting device 10 for mounting a fork blade on an excavator bucket is known from US2005/0129494 A1.

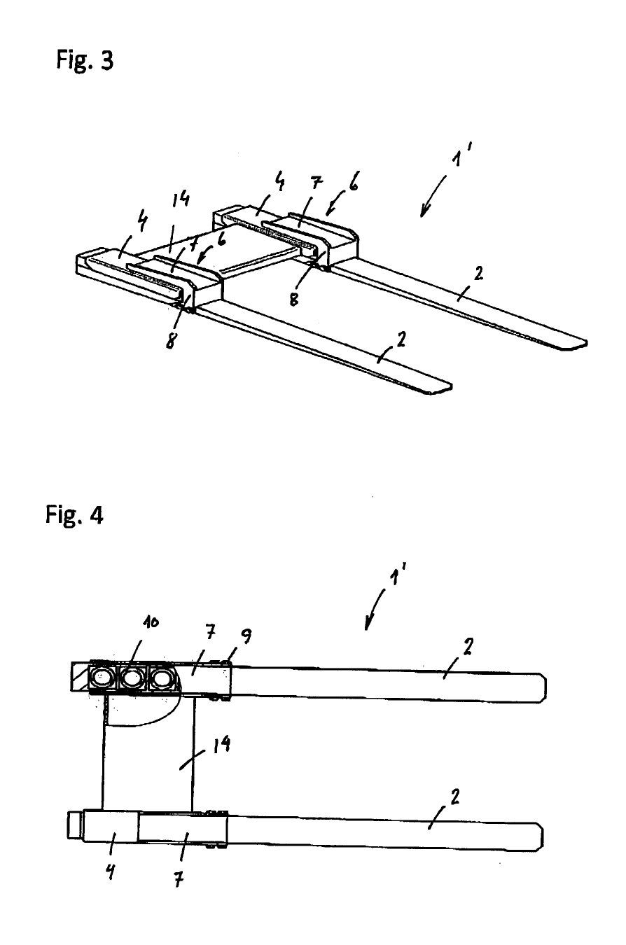

The mounting device 10 is mounted on the rear portion of the fork blade 34 and fixedly secured using a first locking device 18, 36. The mounting device 10 comprises a hook-shaped or U-shaped mounting portion 16, 20, 22, 26, see FIG. 3, which is hooked onto the rear end portion of the bucket 40. The U-shaped mounting portion 16, 20, 22, 26 is fixedly secured to the machine bucket using a second locking device 36. The locking devices are formed by screw joints or bolted joints which are normally mounted by the excavator operator.

One problem with said mounting device is the manual handling involved when mounting the fork on the bucket.

A further problem is the complex design of the mounting device and its limited use to a fork blade.

### Aim of the Invention and its Distinguishing Features

A principal object of the present invention is to provide a mounting device for mounting a fork, preferably a pallet fork, on a bucket without the machine operator having to leave the driver's cab.

A further object of the present invention is to provide a simple mounting device which has a modular structure and which can be used on forks having more than one fork blade.

Said objects, and other aims which are not enumerated here, are satisfactorily achieved by what is specified in the present independent claims.

Embodiments of the invention are defined in the dependent claims.

Thus, according to the present invention, a mounting device for mounting a fork, comprising at least one fork blade, on a machine bucket is provided, wherein the mounting device comprises at least one pre-tensioned plate arranged on said at least one fork blade, and at least one upper tension stop against which said at least one pre-tensioned plate is pre-tensioned for mounting the machine bucket by clamping the machine bucket between the pre-tensioned plate and the upper tension stop.

Further preferred embodiments of the mounting device according to the invention are described below:

According to a second embodiment of the mounting device for mounting a fork, comprising a fork blade on a bucket, the mounting device comprises a pre-tensioned plate and an upper tension stop, wherein the pre-tensioned plate is pre-tensioned using at least two coil springs arranged in a spring plate on the fork blade underneath the plate.

According to a third embodiment of the mounting device for mounting a fork, comprising two fork blades, on a bucket, the mounting device comprises two pre-tensioned plates and two upper tension stops, wherein each of the two pre-tensioned plates is pre-tensioned using at least two coil springs, wherein said at least two coil springs are arranged in spring plates, one on each of the two fork blades, underneath the plates, and wherein the two pre-tensioned plates are fixedly connected to each other via a crossbeam.

According to a fourth embodiment of the mounting device, said at least two coil springs are arranged in recesses in the spring plate for controlling the pre-tensioning in a vertical direction.

According to a fifth embodiment of the mounting device, said at least two coil springs are arranged on protruding guides on the underside of said at least one pre-tensioned plate.

According to a sixth embodiment of the mounting device, said at least one pre-tensioned plate is pre-tensioned using four coil springs.

According to a seventh embodiment of the mounting device, said at least one upper tension stop is formed as a bridge comprising a horizontal bridge portion against which said at least one plate is pre-tensioned, and a vertical bridge portion with which the bridge is mounted on the outer sides of said at least one fork blade.

According to an eighth embodiment of the mounting device, said at least one spring plate is fixedly connected to said at least one upper tension stop in order for said at least one spring plate and said at least one upper tension stop to form at least one coherent unit.

According to a ninth embodiment of the mounting device, the spring plate also comprises at least one lower tension stop for limiting depression of said at least one pre-tensioned plate, wherein said at least one upper tension stop is in the form of a metal lug integrated with the rear portion of said at least one spring plate in connection with the rear end of said at least one fork blade.

According to the present invention, a method has also been provided by which a fork, comprising at least one fork blade arranged on a surface offering firm support, is mounted on a bucket, which method comprises the following steps:

1) Mounting a mounting device of the type mentioned above on the fork blade. 2) Operating the bucket so that the front portion of the bucket rests on the rear portion of the pre-tensioned plate. 3) Operating the bucket so that the bucket depresses the pre-tensioned plate fully or partly to a lower tension stop. 4) Operating the bucket so that the front portion of the bucket is moved into the space between the pre-tensioned plate and the upper tension stop. 5) Operating the bucket so that the bucket and the fork blade are free above the surface offering firm support, so that the pre-tensioned plate clamps the bucket against the upper tension stop.

### Advantages and Effects of the Invention

The invention affords a number of advantages and effects, the most important of which are the following:

The mounting device means that a pallet fork can be mounted, in a quick and simple way, on a bucket which is arranged on a machine such as a wheel loader, a truck or similar, without first having to remove the bucket from the machine and without the driver having to leave the driver's cab of the machine.

The mounting device is of a simple structure and can quickly be removed from one type of fork in order to thereafter quickly be fitted to another type of fork.

The mounting device can also be used on types of work equipment other than forks.

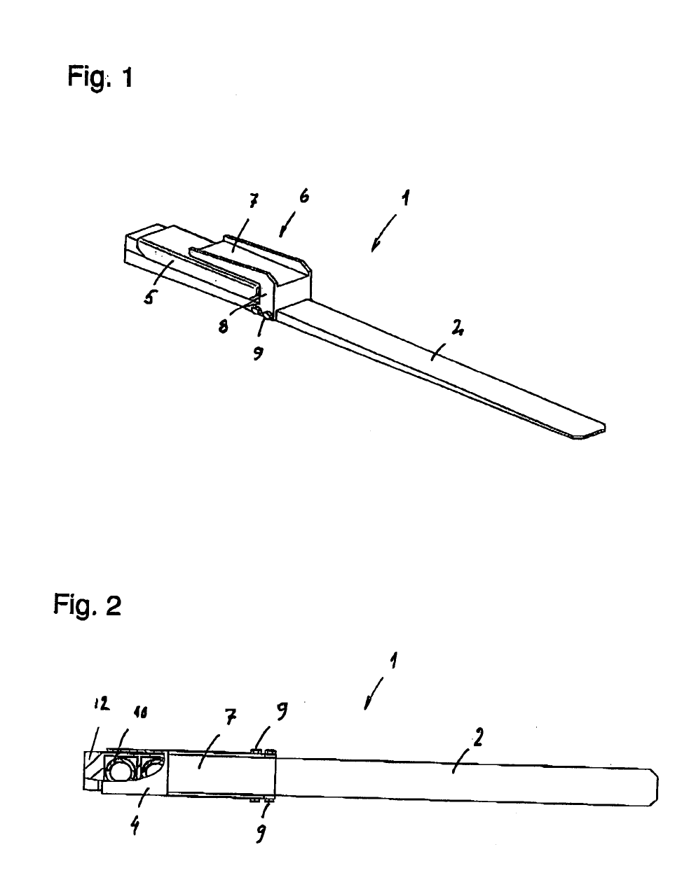

Further advantages and effects of the invention will become clear from studying and considering the following detailed description of the invention and by referring at the same time to the attached FIGS. 1-6, in which

FIG. 1 shows a schematic perspective view, seen obliquely from above, of a mounting device arranged on a fork comprising one fork blade.

FIG. 2 shows a schematic view, seen from above, of a mounting device according to FIG. 1.

FIG. 3 shows a schematic perspective view, seen obliquely from above, of a mounting device arranged on a fork comprising two fork blades.

FIG. 4 shows a schematic view, seen from above, of a mounting device according to FIG. 3.

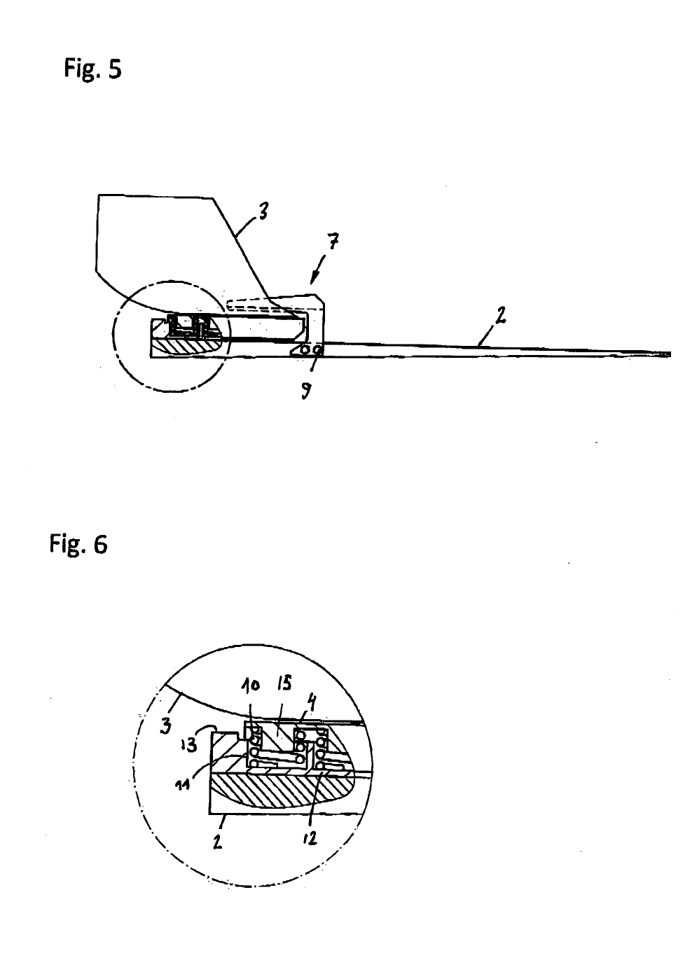

FIG. 5 shows a schematic side view of a mounting device according to FIG. 1 and FIG. 5, showing one of the coil spring attachments to the pressure plate and the spring plate.

FIG. 6 shows an enlarged schematic view of the attachment of a coil spring to the pressure plate and to the spring plate according to FIG. 5.

### DETAILED DESCRIPTION OF EMBODIMENTS

FIGS. 1-4 show two alternative embodiments of a mounting device 1, 1′ according to the invention for mounting a fork 2, preferably a pallet fork, on a bucket 3 fitted to a machine such as a wheel loader, truck or similar. FIGS. 1-2 show two views of a mounting device 1 arranged on a pallet fork comprising one fork blade 2. FIGS. 3-4 show the mounting device 1″ arranged on a pallet fork comprising two fork blades 2. The modular structure of the mounting device 1, 1′ means that it is possible for the mounting device 1, 1′ to be easily used on pallet forks with more than two fork blades 2, not shown.

The mounting device 1, according to FIGS. 1-2, is arranged on the rear portion of the fork blade 2 and comprises a pre-tensioned plate 4, preferably of the pressure plate type which is depressed by a bucket, arranged on the top side of the fork blade 2.

The pre-tensioned plate 4 comprises, preferably two control or side plates 5, one on each side of the plate 4. The function of the control plates 5 is to control the position of the pre-tensioned plate 4 laterally and to prevent uneven loads of the mounting device 1 when the plate 4 is depressed.

The mounting device 1 further comprises an upper tension stop 6 arranged above the pressure plate 4 for fixedly securing the bucket 3 between the pressure plate 4 and the upper tension stop 6. The upper tension stop 6 is, preferably, formed as a bridge, comprising a horizontal bridge portion 7 against which the plate 4 is pre-tensioned, and a vertical bridge portion 8 with which the bridge is mounted on the outer sides of the fork blade 2. The vertical bridge portion 8 is, preferably, mounted in a detachable manner on the fork blade 2 via screw joints or bolted joints 9. Alternatively, the vertical bridge portion 8 is fixedly mounted via welded joints, not shown. In a further alternative embodiment, the vertical bridge portion 8 is forged in one piece together with the fork blade 2, not shown. The horizontal bridge portion 7 is arranged on the front upper portion of the pre-tensioned plate 4 and extends, preferably, over at least half the length of the pre-tensioned plate 4.

FIGS. 5-6 show the pre-tensioned pressure plate 4, pre-tensioned with at least two, preferably four, coil springs 10. Alternatively, the pre-tensioning of the plate is achieved using plungers comprising compressed gas, or using rubber springs comprising a resilient elastic rubber material, not shown.

As shown in FIG. 4, the four coil springs 10 are arranged in a detachable manner in cup-like recesses 11 in a spring plate 12 on the fork blade 2 for controlling the pre-tensioning and the spring force of the coil springs 10 in a vertical direction toward the underside of the pressure plate 4.

The four coil springs 10 are further arranged on protruding guides 15 on the underside of the plate 4 for controlling and fixing the coil springs 10 in a vertical direction.

The spring plate 12 is, preferably, mounted in a detachable manner between the pressure plate 4 and the fork blade 2. In an alternative embodiment, not shown, the spring plate 12 and the vertical bridge portion 7 are fixedly connected to each other via a welded joint, not shown, so that the spring plate 12 and the upper tension stop 6 form a coherent unit, not shown.

The mounting device 1 according to FIGS. 1 and 2 further comprises a lower tension stop 13, arranged on the rear portion of the fork blade 2. The lower tension stop 13 is, preferably, an integrated portion of the rear portion of the spring plate 12 and has the form of a metal lug. Alternatively, the lower tension stop 13 forms a separate component, in the form of a metal plate, fixedly mounted on the fork blade 2 behind the spring plate 12, in connection with the rear end of the fork blade 2, wherein the lower tension stop 13 acts as a rear stop for movements of the spring plate 12 on the fork blade 2 in an axial direction. The lower tension stop 13 limits the downward movement of the pressure plate 4 in a vertical direction when the pressure plate 4 is depressed by a bucket, and it also prevents the pressure plate 4 from being angled rearward when depressed.

FIGS. 3-4 show an embodiment of the mounting device 1′ for mounting a pallet fork, comprising two fork blades 2, on a bucket. The mounting device 1′ comprises two similar mounting devices 1, achieved according to FIGS. 1-2. The two mounting devices 1 are mounted on the two fork blades 2 and are fixedly connected to each other via a crossbeam 14.

The crossbeam 14 is, preferably mounted on the control plates 5 of each pressure plate 4, preferably via welded joints. Alternatively, the crossbeam 14 is mounted in a detachable manner on the control plates 5 via bolted joints or screw joints, not shown.

In a further embodiment, the crossbeam 14 comprises a control device for controlling the distance between the two fork blades 2, not shown.

A method for mounting a pallet fork, comprising one fork blade 2, on a machine bucket 3, comprises the following steps: 1) Mounting a mounting device 1 on the fork blade 2 which is positioned on a surface offering firm support. 2) Operating the bucket 3 so that the front portion of the bucket 3 rests on the pre-tensioned plate 4. 4) Operating the bucket 3 so that the pre-tensioned plate 4 is fully or partly depressed to the lower tension stop 13. 5) Operating the bucket 3 so that the front portion of the bucket 3 is moved in between the pre-tensioned plate 4 and the upper tension stop 6. 6) Operating the bucket 3 so that the bucket 3 with the fork blade 2 is situated above the firm surface so that the pre-tensioning of the plate clamps the bucket 3 between the plate 4 and the upper tension stop 6. Alternatively, it may be entirely sufficient to angle the bucket for the pre-tensioning of the plate to clamp the bucket.

A method for removing the fork blade 2 from the bucket comprises the following steps: 1) Operating the bucket 3 so that the front portion of the bucket 3 depresses the pressure plate 4 toward the lower tension stop 13. Operating the bucket 3 so that the front portion of the bucket 3 is pulled rearward and moved out of the gap between the pressure plate 4 and the tension stop 6, so that the fork blade 2 is released from the bucket 3.

The invention is not limited to the embodiments shown and can instead be varied in different ways within the scope of the patent claims.

1. A mounting device for mounting a fork, comprising at least one fork blade, on a bucket, wherein the mounting device comprises at least one pre-tensioned plate arranged on said at least one fork blade, and at least one upper tension stop against which said at least one pre-tensioned pressure plate is pre-tensioned for mounting the fork on the bucket by clamping the bucket between said at least one pre-tensioned plate and said at least one upper tension stop.

2. The mounting device according to claim 1 for mounting a pallet fork, comprising one fork blade on a machine bucket, wherein the mounting device comprises a pre-tensioned pressure plate and an upper tension stop, wherein the plate is pre-tensioned using at least two coil springs arranged in a spring plate on the fork blade underneath the plate.

3. The mounting device according to claim 1 for mounting a fork, comprising two fork blades, on a machine bucket, wherein the mounting device comprises two pre-tensioned pressure plates and two upper tension stops, wherein each of the two plates is pre-tensioned using at least two coil springs, wherein said at least two coil springs are arranged in two spring plates, one on each of the two fork blades, underneath the plates, and wherein the two pre-tensioned plates are fixedly connected to each other via a crossbeam.

4. The mounting device according to claim 1, wherein said at least two coil springs are arranged in recesses in said at least one spring plate for controlling the pre-tensioning of said at least one plate in a vertical direction toward said at least one upper tension stop.

5. The mounting device according to claim 1, wherein said at least two coil springs are mounted on protruding guides on the underside of said at least one plate.

6. The mounting device according to claim 5, wherein said at least one pre-tensioned plate is pre-tensioned using four coil springs.

7. The mounting device according to claim 1, wherein said at least one upper tension stop is formed as a bridge comprising a horizontal bridge portion against which said at least one plate is pre-tensioned, and a vertical bridge portion with which the bridge is mounted on the outer side of said at least one fork blade.

8. The mounting device according to claim 2, wherein said at least one spring plate is fixedly connected to said at least one upper tension stop in order for said at least one spring plate and said at least one upper tension stop to form a coherent unit.

9. The mounting device according to claim 2, wherein said at least one spring plate comprises at least one lower tension stop for limiting depression of said at least one plate in a vertical direction, wherein said at least one lower tension stop is in the form of a metal lug integrated with the rear portion of said at least one spring plate in connection with the rear end of said at least one fork blade.

10. A method by which a fork, comprising a fork blade resting on a surface offering firm support, is mounted on a bucket, which method comprises the following steps: 1) mounting a mounting device, arranged according to at least claim 1 on the fork blade, 2) operating the bucket so that the front portion of the bucket rests on the rear portion of the pre-tensioned plate, 4) operating the bucket so that the bucket depresses the pre-tensioned plate fully or partly to a lower tension stop, 5) operating the bucket so that the front portion of the bucket is moved into the space between the pre-tensioned plate and the upper tension stop, operating the bucket so that the bucket and the fork blade are free above the surface offering firm support, so that the pre-tensioned plate clamps the bucket against the upper tension stop.

11. The mounting device according to claim 2, wherein said at least two coil springs are arranged in recesses in said at least one spring plate for controlling the pre-tensioning of said at least one plate in a vertical direction toward said at least one upper tension stop.

12. The mounting device according to claim 2, wherein said at least two coil springs are mounted on protruding guides on the underside of said at least one plate.

13. The mounting device according to claim 12, wherein said at least one pre-tensioned plate is pre-tensioned using four coil springs.

14. The mounting device according to claim 2, wherein said at least one pre-tensioned plate is pre-tensioned using four coil springs.

15. The mounting device according to claim 2, wherein said at least one upper tension stop is formed as a bridge comprising a horizontal bridge portion against which said at least one plate is pre-tensioned, and a vertical bridge portion with which the bridge is mounted on the outer side of said at least one fork blade.

16. The mounting device according to claim 3, wherein said at least one upper tension stop is formed as a bridge comprising a horizontal bridge portion against which said at least one plate is pre-tensioned, and a vertical bridge portion with which the bridge is mounted on the outer side of said at least one fork blade.

17. The mounting device according to claim 3, wherein said at least one spring plate is fixedly connected to said at least one upper tension stop in order for said at least one spring plate and said at least one upper tension stop to form a coherent unit.

18. The mounting device according to claim 3, wherein said at least one spring plate comprises at least one lower tension stop for limiting depression of said at least one plate in a vertical direction, wherein said at least one lower tension stop is in the form of a metal lug integrated with the rear portion of said at least one spring plate in connection with the rear end of said at least one fork blade.
